(19) United States
(12) Patent Application Publication
(10) Pub. No.: US 2026/0184867 A1
(43) Pub. Date: Jul. 2, 2026

(54) DOUBLE-SIDED HEAT-SEALED REGENERATED CELLULOSE FILM

(71) Applicant: Gene Benfatti, Plainfield, NJ (US)

(72) Inventor: Gene Benfatti, Plainfield, NJ (US)

(21) Appl. No.: 19/004,046

(22) Filed: Dec. 27, 2024

(51) Int. Cl. C08J 5/18; C08K 3/04; C08K 7/22

(52) U.S. Cl. CPC C08J 5/18; C08K 3/042; C08K 7/22; C08J 2301/02; C08J 2323/08; C08J 2329/04

(57) ABSTRACT

A high-barrier double-sided heat-sealed regenerated cellulose film made from a composition including 30-60 weight parts of cellulose raw materials; 4.5-9 weight parts of a plasticizer; 3-15 weight parts of polyvinyl alcohol; 10-20 weight parts of graphene oxide; and 15-30 weight parts of a heat-sealing auxiliary agent. The heat-sealing auxiliary agent is PDLLA hollow porous microspheres loaded with resins, such as PCL resins.

### FIELD OF INVENTION

The present invention relates to the field of bioplastic, and more particularly, the present invention relates to a high-barrier double-sided heat-sealed regenerated cellulose film, a preparation process, and composite packaging.

### BACKGROUND

An exponential increase in plastic-based environmental pollution has warranted that all major countries should move towards environmentally friendly materials. Environmentally friendly materials can either be recycled or are biodegradable with significantly less impact on the environment. Regenerated cellulose films made of natural cellulose materials are widely used in many industries, particularly, the food packaging industry. Cellulose-based films have several characteristics that make them an ideal choice for environmentally friendly materials. Examples of such characteristics include transparency, no static electricity, high-temperature resistance, good barrier, and degradability. Cellulose-based films are being widely used in the packaging of food, medicine, cosmetics, precision instruments, and other products.

However, cellulose-based films also have several drawbacks and limitations. The hydrogen bonds in the cellulose structure are tightly bound between the macromolecular chains of cellulose, which is the major drawback. Cellulose-based films cannot be made easily and have no specific melting point range. This makes the heat-sealing performance of cellulose films poor when used as packaging material. At present, the coating method is chiefly used to prepare heat-sealable cellulose films.

In the prior art, many solutions have been proposed to overcome the aforesaid drawbacks of lacking heat-sealing properties. For example, a Chinese Patent Application No. 2011103479071 discloses a preparation method for a heat-sealing film that includes raw material selection, viscose preparation, cellulose regeneration, bleaching, plasticization, coating, drying, and wetting. The coating is completed by adding the paint to the paint tank, making the film pass through the paint tank. The vehicle speed is controlled at 60-80 m/min during coating, and the coating amount of the paint is controlled at 1.5-3.0 g/m², it is characterized in that the raw material composition of the described coating and its weight ratio is: water-based polyurethane 80-90 kg, slip agent 0.3-0.6 kg, E-wax emulsion 0.2-0.4 kg, demineralized water 110-120 kg. In the disclosure, the heat-sealing property is realized only through the coating without any modification to the cellulose film. Many coating ingredients are not environmentally friendly and thus undesirable.

A need is therefore appreciated for a high-barrier double-sided heat-sealed regenerated cellulose film that overcomes the aforementioned drawbacks.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a composition and process of preparing regenerative cellulose film that has heat-sealing properties.

Another object of the present invention is that cellulose films are high-barrier double-sided heat-sealing regenerated cellulose films.

Still, another object of the present invention is that cellulose films can be used in food packaging.

A further object of the present invention is that the regenerated cellulose film has strong barrier properties.

Still, a further object of the present invention is that cellulose films have excellent antibacterial properties.

Yet a further object of the present invention is that the cellulose film has high self-heat-sealing strength.

Yet a further object of this invention is that the cellulose film has strong barrier properties at the heat-sealing portions.

An additional object of the present invention is that the cellulose film has good gas and oxygen resistance effects.

In one aspect, the disclosed are a composition for preparing a cellulose film, a process of preparing the cellulose film, and the cellulose film. The cellulose film may be prepared from the following weight parts of raw materials: 30-60 parts of cellulose raw materials, 4.5-9 parts of plasticizer, 3-15 parts of polyvinyl alcohol, 10-20 parts of graphene oxide, 15-30 parts of heat-sealing auxiliaries. The heat-sealing auxiliary agent may be a poly(DL-lactide) (PDLLA) hollow porous microsphere loaded with Polycaprolactone resin (PCL) internally, and the mass ratio of PDLLA hollow porous microsphere and PCL resin is 1:0.1-0.2.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

### Abbreviations

PBS—Poly(butylene succinate)
PHA—Polyhydroxyalkanoates
PPC—Polypropylene carbonate
PBAT—Polybutylene adipate co-terephthalate
PLA—Polylactic Acid
PDLLA—poly-d,l-lactic acid
PCL—Polycaprolactone
EVA—Ethylene Vinyl Acetate

Disclosed is a high-barrier double-sided heat-sealed regenerated cellulose film, a preparation method thereof, and composite packaging.

In certain implementations, disclosed is a high-barrier double-sided heat-sealed regenerated cellulose film that may include the raw materials of the following weight parts: 30-60 parts of cellulose raw materials, 4.5-9 parts of plasticizer, 3-15 parts of polyvinyl alcohol, 10-20 parts of graphene oxide, and 15-30 parts of heat-sealing auxiliaries. The heat-sealing auxiliary agent may be a PDLLA (a biodegradable polymer) hollow porous microsphere loaded with PCL resin internally, and the mass ratio of PDLLA hollow porous microsphere and PCL resin is 1:0.1-0.2.

Using graphene oxide, polyvinyl alcohol, and cellulose raw materials as the main raw materials, there is a strong hydrogen bond interaction between graphene oxide and cellulose molecular chains. The graphene oxide sheets and the cellulose molecular chains, oriented under hydrogen bonding, move together and are arranged in the direction parallel to the film. This makes the structure of the regenerated cellulose film dense, and the film is smooth and compact. The tensile strength and elongation at break property of the film are significantly improved. Moreover, the interface interaction between graphene oxide and cellulose molecules is good. The complete peeling and high orientation of graphene oxide reduces the diffusion coefficient of water vapor, extends the diffusion path, and improves the barrier to water vapor. There is hydrogen bonding between polyvinyl alcohol and cellulose, which can improve the mechanical properties of the regenerated cellulose membrane, and the two have similar chemical structures and surface energy. The polyvinyl alcohol and cellulose can be better blended so that the pores of the cellulose membrane are smaller, and the gas resistance is enhanced. There is also hydrogen bonding between graphene oxide and polyvinyl alcohol, and graphene oxide can improve the water-resistance of polyvinyl alcohol, and the interaction between the three can jointly improve the mechanical strength and barrier properties of regenerated cellulose films. In addition, the PDLLA hollow porous microspheres with PCL resin in the internal pores are added as heat-sealing aids. The PDLLA hollow porous microspheres have a porous internal structure and good heat resistance, but the PCL resin contained within the pores has high crystallinity and low melting points. The PCL resin offers low-temperature molding, excellent adhesion on the difficult-to-bond substrate, and good compatibility with a variety of polymers. When the regenerated cellulose film is heat-sealed, the heat-sealing temperature makes the internal PCL resin melt and flow out from the pores of the PDLLA hollow porous microsphere. Under the action of hot pressing, the adjacent regenerated cellulose film is heat-sealed and bonded. Thus, the disclosed regenerated cellulose film has excellent heat-sealing performance. The adhesive strength of PCL resin is large, so the heat-sealing strength is high, and the adhesion is strong. The raw materials are degradable and thus environmentally friendly.

In certain implementations, the heat-sealing auxiliary agent may be prepared by the following method. First, the PCL resin and low melting point EVA resin are crushed and ground to make mixed resin powder. The mass ratio of PCL resin to low melting point EVA resin is 1:0.1-0.3. Separately, PDLLA hollow porous microspheres may be added to sodium hydroxide solution, soaked for 20-30 min, removed, washed, and dried to prepare pretreated PDLLA hollow porous microspheres. The pretreated PDLLA hollow porous microspheres are then dispersed into an ethanol solution. The mixed resin powder is added by stirring evenly and the mixture is treated at low pressure for 8-10 h, and the low-pressure treatment is repeated 2-3 times after standing, washed with absolute ethanol, centrifuged, and dried.

The low melting point EVA resin and PCL resin as heat-sealing adhesive materials, offer several advantages. EVA resin has a melting point of 73° C., good flexibility, high elasticity, transparency, good surface gloss, and chemical stability. EVA is a new generation of environmentally friendly degradable material. As a thermoplastic hot melt powder, it has good adhesion with most materials. It has high initial peel strength, fast bonding speed, and a wide bonding range. The pretreatment of the PDLLA hollow porous microspheres allows for more mixed resin powder to be loaded, thus further improving the heat-sealing strength. After being soaked in sodium hydroxide solution, the surface structure of PDLLA hollow porous microspheres is not damaged, the roughness and the porosity increase.

In certain implementations, the pretreated PDLLA hollow porous microspheres may be further treated for improved properties, however, such a step may be optional. The pretreated PDLLA hollow porous microspheres, as described above, may be added to dopamine solution and stirred for 5-6 h. After 5-6 h the PDLLA hollow porous microspheres can be washed and dried. Then, a silver nitrate solution may be added, add then reduced under low pressure for 2-3 h, centrifuged, washed, and dried. Thereafter, impregnated in dodecyl thiol solution for 1-3 min, filtered and dried.

Treatment of PDLLA hollow porous microspheres with sodium hydroxide solution results in the introduction of hydroxyl groups on the surface of the PDLLA hollow porous microspheres. The surface has strong hydrophilic properties and the porosity also increases. Also, after the melted mixed resin powder flows out for sealing, the porosity of the hollow porous position of PDLLA further increases in at the heat-sealing portion. The hydrophilic pores and surfaces may lead to an increase in water permeability and decrease in water resistance at the heat-sealing portions. So, the secondary treatment of PDLLA hollow porous microsphere with dopamine and silver nitrate, as described above, may make the surfaces hydrophobic. Using the viscosity of polydopamine, the surface or pores of the PDLLA hollow porous microspheres treated with sodium hydroxide solution bond with nano-silver particles. Further upon treatment with dodecyl mercaptan, there is a strong interaction between silver and sulfur. The nano-silver on the surface or in the pores of the PDLLA hollow porous microspheres may be hydrophobic. Moreover, the existence of nano-silver particles can increase the surface coarse friction to a certain extent, better fix the dodecyl mercaptan, and improve the hydrophobic water-holding capacity.

When the treated PLDDA hollow porous microspheres with hydrophobic properties are loaded with mixed resin powder at low pressure, they show good compatibility with the mixed resin powder and faster loading of the resin. The dual-treated PDLLA hollow porous microspheres show improved gas barrier properties. Also, after heat sealing, the hydrophobic PLDDA hollow porous microspheres improve the water resistance at the heat-sealing portion. In the non-heat-sealing portion, due to the nano silver particles on the surface or in the pores, the density of the regenerated cellulose film increases, the antibacterial property is improved, and the barrier ability is enhanced.

In certain implementations, the heat-sealing auxiliary agent may be further treated. The heat-sealing auxiliary agent obtained by loading the pre-treated PDLLA hollow porous microspheres with resins may be added to a polyethyleneimine solution having a concentration of 45-50 wt. %. To the mixture, carboxylate carbon nanotubes may be added and subjected to ultrasonication for 1-1.5 h. Thereafter, an octadecyl trichlorosilane solution may be added and again subjected to ultrasonication for 1-1.5 h, followed by centrifugation, and the supernatant may be discarded. The solids may be washed with water and dried, for example at 40-50° C. The mass ratio of the resulting product may be polyethyleneimine solution, carboxylate carbon nanotubes, and octadecyl trichlorosilane solutions are 1:2-2.4:1-1.2:0.5-1.

By adopting the above technical scheme, the surface of PDLLA hollow porous microspheres loaded with mixed resin powder is post-treated with polyethyleneimine solution, carboxylate carbon nanotubes, and octadecyl trichlorosilane. Treating carbon nanotubes with strong acid results in the addition of a large number of carboxyl groups, hydroxyl groups, and other functional groups on their ports and outer walls, so that the surface is negatively charged. The positively charged polyethyleneimine may combine by electrostatic adsorption, which can increase the dispersion and stability of carbon nanotubes in water and prevent the agglomeration of carbon nanotubes. Moreover, the combination of the carboxylate carbon nanotubes and polyethyleneimine reduces the hydroxyl content on carbon nanotubes increasing the hydrophobicity of carbon nanotubes, and the carbon nanotubes can extend the permeation path and improve barrier properties. Then, the silanol groups produced after the hydrolysis of octadecyl trichlorosilane may further combine with the hydroxyl group on the acidified carbon nanotube, so that the octadecyl trichlorosilane is grafted on the carbon nanotube. A layer of self-assembly film with low surface energy is formed on the carbon nanotube. This increases the surface roughness of the carbon nanotube and reduces its surface-free energy. The carbon nanotube becomes more hydrophobic, which adds to the hydrophobicity of the heat-sealing aid. The heat-sealing auxiliary agent can improve the barrier property of the regenerated cellulose film in both the heat-selling and non-heat-sealing portions.

In certain implementations, the PDLLA hollow porous microspheres may be prepared by dissolving PDLLA in ethyl acetate. To it, ammonium bicarbonate solution may be added and stirred in an ice water bath for 3-5 min. Thereafter polyvinyl alcohol solution may be added and stirred for 5-5.5 h, pelletized, and the microspheres are washed in distilled water 4-6 times. Ethyl acetate may be used as an organic solvent and ammonium bicarbonate may be used as a pore-forming agent, and the PDLLA vacuum porous microspheres are made with smooth surfaces and large porosity.

In certain implementations, disclosed is a preparation method for the high-barrier double-sided heat-sealed regenerated cellulose film. First, the cellulose raw material may be added to the solvent and stirred evenly. Any insoluble matter may be removed by centrifugation. Thereafter, plasticizer may be added to the cellulose solution and mixed. Separately, Polyvinyl alcohol solution in a concentration of 3-5 wt. % may be prepared by adding polyvinyl alcohol to deionized water and heating to 90-95° C. Thereafter, keeping the solution warm and stirring for 1.5-2 h. polyvinyl alcohol solution may then be cooled.

Graphene oxide and heat-sealing auxiliary may be added to the polyvinyl alcohol solution as prepared above while mixing to obtain a treatment solution. The cellulose solution and the treatment solution may be mixed to obtain the mixture. A layer of mixed liquid may be scraped on the PTFE board, and after solidification in a solidification bath, it may be washed with deionized water to neutral, and then hot-pressed and dried at 60-65° C., and the scraping-solidification-washing, and hot-pressure drying may be repeated for 8-10 times to make a regenerated cellulose film.

In certain implementations, the plasticized used for forming the regenerated cellulose film may include glycerol and sorbitol in a mass ratio of about 1.0:0.5-1.0. Glycerol and sorbitol as plasticizers can weaken the intermolecular and intramolecular hydrogen bond interactions in the regenerated cellulose film, and further increase the ease of sliding of the molecular chain when heated, which can improve the heat-sealing performance of regenerated cellulose.

In certain implementations, the cellulose raw material may be selected from at least one of reed pulp, cotton linters, and wheat straw pulp.

By adopting the above-mentioned technical scheme, the mixture of cellulose solution, polyvinyl alcohol, and graphene oxide is poured layer by layer after mixing, and a chemical reaction occurs between regenerated cellulose, polyvinyl alcohol, and graphene oxide in the mixture to form hydrogen bonding, which improves the mechanical properties and gas barrier properties of the film. In addition, the layer-by-layer coating can avoid the large thickness of the casting film solution in the coating process, and the added graphene oxide and the heat sealing auxiliary agent are difficult to affect by the sheer force, so the graphene oxide on the surface of the film has orientation, and the graphene oxide and the heat sealing auxiliary inside the film cannot be randomly distributed in the polymer by shear force, and the layer-by-layer coating and layer-by-layer hot pressing method can effectively avoid the generation of skin core structure. Also, with the layer-by-layer hot pressing action, the cellulose film may have good compactness, high smoothness, and good gas resistance. Evenly distributed heat-sealing additives improve the heat salability of the film. Compared with the coating method to obtain the heat-sealable layer on the regenerated cellulose film, the direct blending method may be used to prepare the heat-sealable regenerated cellulose, and the process may be more convenient.

In certain implementations, the regenerated cellulose membrane can be further treated for hydrophobicity and antimicrobial properties. A mixture of Polydimethylsiloxane (PDMS) solution in a concentration of 0.04-0.1 g/ml, peppermint essential oil-loaded chitosan microcapsules, and Dodecyltrimethoxysilane in a mass ratio of about 1:0.1-0.3:0.1-0.3, may be applied to the surface of the regenerated cellulose membrane and cured at room temperature. Graphene oxide and regenerated cellulose in the regenerated cellulose membrane are hydrophilic. Also, improved antimicrobial activity of the regenerated cellulose membrane may be desired. For this, the surface of the regenerated cellulose membrane may be coated with the PDMS solution containing peppermint essential oil microcapsules, and dodecyl trimethoxy silane. At room temperature, the condensation between the hydroxyl group on the surface of chitosan and the methoxy group of dodecyltrimethoxysilane makes many long alkyl chain groups grafted to the surface of peppermint essential oil microcapsules to make them hydrophobic. After the PDMS solution is cured, the peppermint essential oil microcapsules are embedded in the coating to provide a certain roughness and surface hydrophobicity. In this way, the water vapor barrier and antibacterial properties of the regenerated cellulose membrane can be improved.

Optionally, the solvent may be zinc chloride solution in a concentration of about 45-65%. For cellulose, cellophane is a sustainable, biodegradable, and compostable alternative to plastic bags. Cellophane is made from cellulose which is a renewable resource and is resistant to moisture, oil, and heat. Cellulose nanofibers can be used to make eco-friendly hydrogels and moldings for health care, biotech, and other applications. Biopolymers can be used as a replacement for plastics in product packaging. Natural-based plasticizers which include epoxidized vegetable oils from soybeans, linseed, castor, and sunflower oil, as well as fatty acid esters can also be used. Glycerol and sorbitol plasticizers may reduce internal hydrogen bonds, making the matrix in bioplastics less dense. Synthesized plasticizers including propylene glycol monoacetate, propylene glycol esters of fatty acids, and epoxidized propylene glycol esters may also be used. Strong acids, such as Trifluoroacetic acid (TFA) can esterify the hydroxyl groups of cellulose to produce trifluoroacetate.

In certain implementations, disclosed is composite packaging in the form of a film or bag. The composite packaging may be made from the disclosed high-barrier double-sided heat-sealing regenerated cellulose films. The composite packaging may also include degradable glue and at least a composite layer. The composite layer may be selected from a high-barrier double-sided heat-sealing regenerated cellulose film, PBS film, PHA film, PPC film, PBAT film, PLA aluminized film, paper, and aluminum foil. The adjacent composite layers are bonded through degradable glue.

By adopting the above-mentioned technical scheme, the regenerated cellulose film made by using degradable glue is compounded with the rest of the film, and the composite packaging film or composite packaging bag with high barrier properties and heat sealable can be obtained.

Optionally, the composite packaging film or composite packaging bag may include a high-barrier double-sided heat-sealed regenerated cellulose film, degradable glue, and PBS film from the outside to the inside.

Optionally, the composite packaging film or composite packaging bag includes high-barrier double-sided heat-sealed regenerated cellulose film, degradable glue and PLA aluminized film from the outside to the inside.

Optionally, the composite packaging film or composite packaging bag includes high-barrier double-sided heat-sealed regenerated cellulose film, degradable glue and high-barrier double-sided heat-sealed regenerated cellulose film from outside to inside.

Optionally, composite packaging film or composite packaging bag is sequentially packed with high-barrier double-sided heat-sealed regenerated cellulose film, degradable glue, and paper from inside to outside.

The disclosed composition for regenerated cellulose films and the process of preparing thereof offer several advantages and uses throughout the industries. The disclosed regenerated cellulose film shows good mechanical properties and strong water-blocking ability. Also, the heat-sealing auxiliary, besides providing heat-sealing properties, can improve the overall barrier properties and compactness of the regenerated cellulose film. All the raw materials used in the film are biodegradable and environmentally friendly.

PCL resin and low melting point EVA resin may preferably be used as heat-sealing adhesive materials, which can be loaded on the pores or surfaces of PDLLA hollow porous microspheres. The PDLLA hollow porous microspheres may be pretreated with polydopamine, nano-silver particles, and dodecyl thiol, so that they may have antibacterial and hydrophobic properties, and the porosity of PDLLA hollow porous microspheres increase after the adhesive material flows out at the heat-sealing position, but it still has the good water-blocking effect and antibacterial effect because of the hydrophobic treatment.

In the preparation process, polyethyleneimine, carboxylate carbon nanotubes, and octadecyl trichlorosilane may be preferably used to post-treat the heat-sealing auxiliary, which improves the hydrophobicity of the surface of the heat-sealing auxiliary and improves the barrier property of the regenerated cellulose film.

The method of the present application preferably adopts layer-by-layer pouring and layer-by-layer hot pressing methods, and the regenerated cellulose film prepared has high density, good smoothness, and strong barrier ability.

### Example A

### Preparation of PDLLA Hollow Porous Microspheres

Dissolve 125 mg PDLLA in 4 ml of ethyl acetate, add 0.1 ml of ammonium bicarbonate solution with a concentration of 90 g/ml, stir at 11600 rpm in an ice water bath for 3-5 min, add to 150 ml of polyvinyl alcohol solution with a concentration of 0.1 wt. %, stir for 5 h, form a ball, and wash the microspheres in distilled water for 4 times.

### Preparation of the Heat-Sealing Auxiliary (Examples 1-12)

In the following preparation example, PCL resin was obtained from Perstorp®, Sweden, Perstorp CAPA® 6500. Low melting point EVA resin grade 420 was used.

### Example 1

(1) PCL resin and low melting point EVA resin are crushed and ground to make mixed resin powder, and the mass ratio of PCL resin to low melting point EVA resin is 1:0.3;

(2) Take 1 kg of PDLLA hollow porous microspheres, the mass ratio of PDLLA hollow porous microspheres to PCL resin is 1:0.2, add PDLLA hollow porous microspheres to sodium hydroxide solution with a concentration of 0.1 mol/l, soak for 30 min, take out, wash and dry with deionized water to prepare pretreated PDLLA hollow porous microspheres. PDLLA hollow porous microspheres were made from Example A;

(3) The pretreated PDLLA hollow porous microspheres were dispersed into an ethanol solution of 1 mol/l. Mixed resin powder was added after stirring evenly and treated at a pressure of 0.1 MPa for 10 h. The low-pressure treatment was repeated 3 times after standing. Thereafter, washed with absolute ethanol, centrifuged, and dried.

### Example 2

(1) PCL resin and low melting point EVA resin were crushed and grounded to make mixed resin powder. The mass ratio of PCL resin to low melting point EVA resin was 1:0.1;

(2) Taken 1 kg of PDLLA hollow porous microspheres, the mass ratio of PDLLA hollow porous microspheres to PCL resin is 1:0.1. Add PDLLA hollow porous microspheres to a sodium hydroxide solution with a concentration of 0.1 mol/l, soak for 20 min. Thereafter, take out, wash, and dry with deionized water to prepare pretreated PDLLA hollow porous microspheres. The PDLLA hollow porous microspheres were made using Example A;

(3) the pretreated PDLLA hollow porous microspheres were dispersed into a 1 mol/l ethanol solution, mixed resin powder was added after stirring evenly, treated at a pressure of 0.25 MPa for 8 h, repeated low-pressure treatment twice after standing, washed with absolute ethanol, centrifuged and dried.

### Example 3

The difference from Example 1 is that no low melting point EVA resin is added in step (1).

### Example 4

(1) PCL resin and low melting point EVA resin were crushed and grounded to make mixed resin powder, and the mass ratio of PCL resin to low melting point EVA resin was 1:0.3;

(2) Dispersed 1 kg of PDLLA hollow porous microspheres into 1 mol/l ethanol solution, stirred well, added mixed resin powder, treated at a pressure of 0.1 MPa for 10 h, repeat the low-pressure treatment 3 times after standing, washed with absolute ethanol, centrifuged, dried. PDLLA hollow porous microspheres were made as in Example 1. The mass ratio of PDLLA hollow porous microspheres to PCL resin was 1:0.2.

### Example 5

The difference from Example 1 is that the following pretreatment steps are carried out before the pretreatment of PDLLA hollow porous microspheres dispersed into ethanol solution, and the specific method is as follows:

The pretreated PDLLA hollow porous microspheres were placed in dopamine solution, stirred for 6 h, taken out, washed with deionized water, dried, added to a silver nitrate solution with a concentration of 50 mmol, sodium borohydride was added, stirred, and reduced at 0.5 MPa for 3 h, centrifuged, washed and dried, impregnated in a dodecyl thiol solution with a concentration of 0.05 mol/l for 3 min, filtered. The mass ratio of dry, pretreated PDLLA hollow porous microspheres to silver nitrate solution was 1:0.03. The molar ratio of sodium borohydride to silver nitrate was 1:1. The concentration of dopamine solution was 2 g/l, and it was prepared with Tris-HCl buffer (10 mmol solution of trismethylol aminomethane configuration, pH=8.5).

### Example 6

The difference from Example 5 is that no dodecyl thiol solution is added.

### Example 7

The difference from Example 5 is that no dopamine is added.

### Example 8

The difference from Example 5 is that no silver nitrate solution is added.

### Example 9

The difference from Example 1 is that the method further includes step (4): the substance obtained from step (3) is placed in a polyethyleneimine solution with a concentration of 50 wt. %, carboxylate carbon nanotubes were added, and sonicated for 1.5 h, an octadecyl trichlorosilane solution with a concentration of 0.05 mol/l was added, sonicated for 1.5 h, centrifuged, the supernatant was discarded, washed with distilled water for 5 times, and dried at 50° C. Carboxyl carbon nanotubes were made by mixing carbon nanotubes with concentrated sulfuric acid and concentrated nitric acid with a volume ratio of 3:1 for 0.5 h at room temperature, heating and refluxing at 120° C. for 4 h, washing to neutral with distilled water after cooling, and drying at 70° C. The mass ratio of the obtained product in step (3), polyethyleneimine solution, carboxylate carbon nanotubes, and octadecyl trichlorosilane solutions were 1:2.4:1.2:1.

### Example 10

The difference from Example 9 is that no octadecyl trichlorosilane solution was added.

### Example 11

The difference from Example 9 is that no carboxylate carbon nanotubes were added.

### Example 12

(1) PCL resin and low melting point EVA resin were crushed and grounded to make mixed resin powder, and the mass ratio of PCL resin to low melting point EVA resin was 1:0.3;

(2) Taken 1 kg of PDLLA hollow porous microspheres, the mass ratio of PDLLA hollow porous microspheres to PCL resin is 1:0.2. Added PDLLA hollow porous microspheres to sodium hydroxide solution with a concentration of 0.1 mol/l, soak for 30 min, take out, wash and dry with deionized water to prepare pretreated PDLLA hollow porous microspheres. The PDLLA hollow porous microspheres were prepared as in Example A;

(3) The pretreated PDLLA hollow porous microspheres were placed in dopamine solution, stirred for 5-6 h, removed, washed, and dried with deionized water, added to a silver nitrate solution with a concentration of 50 mmol, added sodium borohydride, stirred and reduced at 0.5 MPa for 3 h, centrifuged, washed and dried, and impregnated in a dodecyl mercaptan solution with a concentration of 0.05 mol/l for 3 min. After filtration and drying, it was dispersed into a 1 mol/l ethanol solution, mixed resin powder was added after stirring evenly, treated at a pressure of 0.1 MPa for 10 h, repeated at low pressure for 3 times after standing, washed with absolute ethanol, centrifuged and dried. The mass ratio of pretreated PDLLA hollow porous microspheres to silver nitrate solution is 1:0.03, and the molar ratio of sodium borohydride and silver nitrate is 11. The concentration of dopamine solution is 2 g/l, which is prepared with Tris-HCl buffer (10 mmol solution of trimethylol aminomethane, pH=8.5).

(4): Place the obtained substance from step (3) in a polyethyleneimine solution with a concentration of 50 wt. %, add carboxylate carbon nanotubes, sonicate for 1.5 h, add an octadecyl trichlorosilane solution with a concentration of 0.05 mol/l, sonicate for 1.5 h, centrifuge, discard the supernatant, wash 5 times with distilled water, and dry at 50° C. The carboxylate carbon nanotubes were prepared from carbon nanotubes in a mixture of concentrated sulfuric acid and concentrated nitric acid, mixed at room temperature for 0.5 h, heated and refluxed at 120° C. for 4 h, washed to neutral with distilled water after cooling, and dried at 70° C. The mass ratio of the obtained product in step (3), polyethyleneimine solution, carboxylate carbon nanotubes, and octadecyl trichlorosilane solution was 1:2.4:1.2:1.

### Embodiment 1

A high-barrier double-sided heat-sealed regenerated cellulose film, the raw material dosage is shown in Table 1, wherein the solvent is a zinc chloride solution with a concentration of 65 wt. %, the cellulose raw material is cotton linters, the plasticizer is glycerol and sorbitol with a mass ratio of 1:1, and the heat-sealing auxiliary is made in Example 1.

The preparation method of the above-mentioned high-barrier double-sided heat-sealed regenerated cellulose film includes the following steps:
S1. Add the cellulose raw material to the solvent, stir evenly, centrifuge, remove the insoluble matter, add plasticizer, and mix well to prepare a cellulose solution with a concentration of 6 wt. %, and the solvent is a zinc chloride solution with a concentration of 45 wt. %;
S2. Polyvinyl alcohol was added to deionized water, heated to 95° C., kept warm, stirred for 1.5 h, cooled, and prepared a polyvinyl alcohol solution with a concentration of 5 wt. %.
S3. Add graphene oxide and heat-sealing auxiliary agent to the polyvinyl alcohol solution, mix evenly, and prepare the treatment solution;
S4. Mix the cellulose solution with the treatment solution to prepare the mixed solution;
S5. A layer of mixed liquid was scraped on the PTFE board, solidified in a sulfuric acid solidification bath having a concentration of 5 wt. %, washed with deionized water to neutral, and hot-pressed and dried at 60° C. and 0.02 MP. Scraping-solidification-washing and hot-press drying 10 times were repeated to make a regenerated cellulose film with a thickness of 40 μm.

TABLE 1

| | Embodi- | Embodi- | Embodi- | Embodi- |
|---|---|---|---|---|
| Raw materials | ment 1 | ment 2 | ment 3 | ment 4 |
| Cellulose raw | 60 | 50 | 40 | 30 |
| materials | | | | |
| plasticizer | 9 | 7 | 6 | 4.5 |
| polyvinyl alcohol | 15 | 11 | 7 | 3 |
| Graphene oxide | 20 | 15 | 10 | 3 |
| Heat sealing aids | 30 | 25 | 20 | 15 |

### Embodiment 2

A high-barrier double-sided heat-sealing regenerated cellulose film prepared by using the raw material dosage shown in Table 1, wherein the cellulose raw material is cotton linters, the plasticizer is glycerol and sorbitol with a mass ratio of 1:0.5, and the heat-sealing auxiliary of Example 2.

The preparation method of the above-mentioned high-barrier double-sided heat-sealed regenerated cellulose film includes the following steps:
S1. Add the cellulose raw material to the solvent, stir evenly, centrifuge, remove the insoluble matter, add plasticizer, and mix well to obtain a cellulose solution with a concentration of 5 wt. %, and the solvent is a zinc chloride solution with a concentration of 50 wt. %
S2. Polyvinyl alcohol was added to deionized water, heated to 90° C., insulated and stirred for 2 h, cooled, and polyvinyl alcohol solution with a concentration of 4 wt. % was prepared.
S3. Add graphene oxide and heat-sealing auxiliary agent to the polyvinyl alcohol solution, mix evenly, and prepare the treatment solution;
S4. Mix the cellulose solution with the treatment solution to prepare the mixed solution;
S5. A layer of mixed liquid was scraped on the PTFE board and solidified in a sulfuric acid solidification bath with a concentration of 5 wt. %, washed to neutral with deionized water, hot-pressed dried at 65° C., and a pressure of 0.02 MPa. Scraping-solidification-washing and hot-press drying 8 times were repeated to make a regenerated cellulose membrane with a thickness of 30 μm.

### Embodiment 3-4

A high-barrier double-sided heat-sealed regenerated cellulose film, which is different from embodiment 1 in that the amounts of the raw materials are shown in Table 1.

### Embodiment 5

A high-barrier double-sided heat-sealed regenerated cellulose membrane, which is distinguished from Embodiment 1 in that in step S5, the mixture is completely poured on a PTFE plate, after solidification in a solidification bath, washed to neutral with deionized water, and dried at 65° C.

### Embodiment 6

A high-barrier double-sided heat-sealing regenerated cellulose film, the difference from Embodiment 1 is that the heat-sealing auxiliary of Example 3 was used.

### Embodiment 7

A high-barrier double-sided heat-sealing regenerated cellulose film, the difference from Embodiment 1 is that the heat-sealing auxiliary of Example 4 was used.

### Embodiment 8

A high-barrier double-sided heat-sealing regenerated cellulose film, which is different from Embodiment 1 in that the heat-sealing auxiliary of Example 5 was used.

### Embodiment 9

A high-barrier double-sided heat-sealing regenerated cellulose film, which is different from Embodiment 1 in that the heat-sealing auxiliary of Example 6 was used.

### Embodiment 10

A high-barrier double-sided heat-sealing regenerated cellulose film is prepared, the difference from embodiment 1 is that the heat-sealing auxiliary of Example 7 was used.

### Embodiment 11

A high-barrier double-sided heat-sealing regenerated cellulose film, the difference from embodiment 1 is that the heat-sealing auxiliary of Example 8 was used.

### Embodiment 12

A high-barrier double-sided heat-sealing regenerated cellulose film, the difference from Embodiment 1 is that the heat-sealing auxiliary of Example 9 was used.

### Embodiment 13

A high-barrier double-sided heat-sealing regenerated cellulose film, the difference from Embodiment 1 is that the heat-sealing auxiliary of Example 10 was used.

### Embodiment 14

A high-barrier double-sided heat-sealing regenerated cellulose film, which is distinguished from Example 1 in that the heat-sealing auxiliary of Example 11 was used.

### Embodiment 15

A high-barrier double-sided heat-sealing regenerated cellulose film, the difference from Embodiment 1 is that the heat-sealing auxiliary of Example 12 was used.

### Embodiment 16

A high-barrier double-sided heat-sealed regenerated cellulose film, the difference between it and Embodiment 15 is that the preparation method further comprises S6, brushing a mixture on the surface of the regenerated cellulose film made in step S5, curing at room temperature, and the mixture is composed of a PDMS n-hexane solution with a concentration of 0.1 g/ml with a mass ratio of 1:0.3:0.3. The wall material is made of chitosan peppermint essential oil microcapsules and dodecyltriethoxysilane. The thickness of the mixture after curing was 20 μm. To prepare chitosan peppermint essential oil microcapsules, chitosan was added to acetic acid to make a chitosan solution with a concentration of 3%, and Tween-60 was added to make a mixed solution. The peppermint flavor was dissolved in absolute ethanol, and the flavor solution was added to the mixed solution to form an emulsion and spray-dried to prepare peppermint essential oil microcapsules. The mass ratio of the chitosan solution to the ethanol solution was 10:1, and the amount of Tween-60 was 0.25% of the chitosan solution.

### Embodiment 17

A high-barrier double-sided heat-sealed regenerated cellulose membrane, which is distinguished from embodiment 16 in that a peppermint essential oil microcapsule with chitosan is not added.

### Embodiment 18

A high-barrier double-sided heat-sealed regenerated cellulose film, which is distinguished from embodiment 16 in that dodecyltrimethoxysilane is not added.

### Proportional to the Pair

### Pair Ratio 1

A high-barrier double-sided heat-sealed regenerated cellulose film, which is distinguished from embodiment 1 in that graphene oxide is not added.

### Pair Ratio 2

A high-barrier double-sided heat-sealed regenerated cellulose film, which is distinguished from embodiment 16 in that polyvinyl alcohol is not added.

### Pair Ratio 3

A preparation method for a heat-sealing film comprises the following steps:

(1) Select cotton pulp meal with a weight ratio of 30% and wood pulp meal with a weight ratio, and make viscose through alkalizing, pressing, aging, yellowing, dissolving, maturation, filtration, and defoaming processes, and then beat the viscose into the film former through the viscose metering pump and generate the film through the former. The film is put into the desulfurization tank for desulfurization. After desulfurization, it is transferred to the bleaching tank for bleaching. The bleached film is plasticized after washing, and after plasticization, it is coated;

(2) For paint preparation, 0.3 kg of slip agent and 8 kg of softened water are added to the preparer and stirred for 5 minutes, and then 0.2 kg of E wax emulsion, 80 kg of water-based polyurethane and 112 kg of demineralized water are added to the preparer and stirred for 10 minutes to prepare the coating.

(3) coating, the prepared paint is added to the paint tank, the speed is controlled at 60 m/min, the film passes through the paint tank, coating, the coating amount of the paint is controlled at 1.5 g/m2, and the film is dried and humidified after the coating is completed.

### Performance Test

Performance testing of high-barrier double-sided heat-sealed regenerated cellulose film: prepare high-barrier double-sided heat-sealed regenerated cellulose film according to the embodiment and the method in proportion and test the performance of the regenerated cellulose film with reference to the following method and record the test results in Table 2.

Water vapor permeability rate: tested in accordance with GB/T1037-2021 “Determination of Water Vapor Permeability Performance of Plastic Films and Sheets Cup Weight Gain and Weight Reduction Method”.

Oxygen permeability: tested in accordance with GB/T1038-2000 “Test Method for Gas Permeability of Plastic Film and Sheet Differential Pressure Method”.

The heat-sealing strength of the regenerated cellulose film itself: the regenerated cellulose film is heat sealed, the heat-sealing temperature is 150° C., the heat-sealing time is 0.7 s, the heat-sealing pressure is 0.2 MPa, the heat-sealing width is 60 mm, and the length is 15 mm.

Water vapor transmission rate at the heat-sealing place of regenerated cellulose film: heat seal the regenerated cellulose film itself, the heat-sealing temperature is 150° C., the heat sealing time is 0.7 s, the heat-sealing pressure is 0.2 MPa, the heat sealing width is 100 mm, and the length is 35 mm Cup weight gain and weight loss method” to test the water vapor transmission rate.

Tensile strength: tested in accordance with GB/T22898-2008 “Determination of Tensile Strength of Paper and Cardboard”;

Elongation at break: tested in accordance with GB/T1040.3-2006 “Determination of Tensile Properties of Plastics Part 3: Films and Flakes”.

Antibacterial rate: according to QB/T2591-2003 “Antibacterial Plastics-Antibacterial Performance Test Method and Antibacterial Effect”, the detected bacteria are ATCC27734 Staphylococcus aureus.

TABLE 2
Performance test of high-barrier double-sided heat-sealed regenerated cellulose film:

| | | | Heat | | | | | | |
|---|---|---|---|---|---|---|---|---|---|
| | | | sealing | | | | | | |
| Project | g/m² · | ml/(m² · | strength | g/m² · | N/15 mm | | Elongation at break/% | | Bacteriostatic |
| (Embodiment) | 24 h | 24 h) | g/37 mm | 24 h | Longitudinal | Transverse | Longitudinal | Transverse | rate (%) |
| 1 | 15.1 | 4.51 | 402 | 20.1 | 60.05 | 31.23 | 18.08 | 37.52 | 92.21 |
| 2 | 15.3 | 4.62 | 397 | 20.8 | 59.84 | 31.17 | 18.04 | 37.48 | 91.38 |
| 3 | 15.5 | 4.68 | 395 | 21.5 | 59.35 | 31.06 | 17.91 | 37.42 | 91.02 |
| 4 | 15.9 | 4.81 | 394 | 21.9 | 58.91 | 31.01 | 17.88 | 37.36 | 92.81 |
| 5 | 20.2 | 6.04 | 380 | 25.5 | 53.54 | 28.51 | 15.24 | 34.68 | 92.20 |
| 6 | 15.9 | 4.67 | 370 | 22.3 | 59.89 | 31.20 | 18.12 | 37.51 | 92.21 |
| 7 | 15.2 | 4.65 | 372 | 23.4 | 59.92 | 31.15 | 18.05 | 37.53 | 92.18 |
| 8 | 13.1 | 3.55 | 401 | 18.2 | 61.05 | 32.15 | 18.85 | 38.47 | 95.25 |
| 9 | 14.9 | 3.68 | 396 | 19.4 | 60.58 | 31.84 | 18.45 | 37.78 | 95.20 |
| 10 | 14.6 | 3.72 | 398 | 19.2 | 61.72 | 31.51 | 18.43 | 37.41 | 95.23 |
| 11 | 14.5 | 3.64 | 401 | 19.0 | 60.84 | 31.48 | 18.51 | 37.60 | 92.21 |
| 12 | 11.7 | 3.24 | 403 | 17.6 | 61.22 | 32.31 | 18.91 | 38.71 | 93.28 |
| 13 | 12.4 | 3.45 | 402 | 18.5 | 61.01 | 32.12 | 18.25 | 38.34 | 93.27 |
| 14 | 13.6 | 3.54 | 401 | 18.8 | 61.11 | 32.04 | 18.14 | 38.25 | 92.24 |
| 15 | 10.4 | 3.27 | 403 | 15.4 | 61.25 | 32.34 | 18.92 | 38.82 | 95.38 |
| 16 | 9.1 | 2.82 | 403 | 14.2 | 61.31 | 32.35 | 18.95 | 38.73 | 99.21 |
| 17 | 9.2 | 2.84 | 402 | 14.3 | 61.18 | 32.21 | 18.92 | 38.64 | 95.39 |
| 18 | 10.1 | 2.91 | 402 | 15.2 | 61.12 | 32.15 | 18.90 | 38.81 | 95.38 |
| Pair scale 1 | 21.3 | 7.24 | 402 | 22.3 | 45.12 | 25.41 | 15.11 | 32.22 | 68.25 |
| Pair scale 2 | 18.1 | 8.12 | 401 | 20.2 | 48.67 | 26.41 | 15.37 | 34.11 | 92.15 |
| Pair | 298 | 12.12 | 360 | 452 | 45 | 23 | 18 | 35.4 | 35.62 |
| proportion 3 | | | | | | | | | |

It can be seen from the data in Table 2 that the heat-sealing auxiliary made by using Example 1 in Embodiments 1 and 3-4, and the heat-sealing auxiliary made using Example 2 in Embodiment 2, the regenerated cellulose membrane shows a good water vapor barrier to water vapors. The mechanical properties are strong, and it has good bacteriostatic properties. After heat sealing, the heat-sealing strength is high, and the heat-sealing place is firmly bonded. The heat-sealing place also has a high-water vapor barrier property. It can further improve the packaging tightness of regenerated cellulose film.

In Embodiment 5, a one-time pouring film-forming method is adopted, and the method of pouring and hot-pressing layer by layer is not adopted, and the regenerated cellulose film prepared by Embodiment 5 is significantly reduced compared with Embodiment 1. The barrier performance of water vapor is significantly reduced and the mechanical properties are also reduced, indicating that the method of pouring and hot pressing layer by layer can improve the barrier property and mechanical strength of the regenerated cellulose film to water vapor.

Using heat-sealing auxiliary of example 3 in Embodiment 6, in which low melting point EVA resin was not added, it can be seen from the data in Table 2 that the heat-sealing strength has decreased, the water vapor transmission rate at the heat-sealing site has increased slightly, and the rest of the properties have not changed much, indicating that the low melting point EVA resin loaded in the PDLLA hollow porous microsphere can increase the bonding strength of the heat-sealing place and improve the heat seal ability.

In Embodiment 7, the heat sealing auxiliary of example 4 was not treated with sodium hydroxide solution in the preparation of the PDLLA microspheres, the heat sealing strength decreases, and the water vapor transmission rate at the heat sealing place decreases, indicating that the porosity of the PDLLA hollow porous microspheres in the Example 4 is not as good as that of Example 1, and the loading of mixed resin powder decreases, resulting in the weakening of the heat sealing strength.

Embodiment 8 compared with Embodiment 1, using the heat sealing auxiliary of Example 5, using polydopamine, silver nitrate, and dodecyl mercaptan, etc., to pretreat the PDLLA hollow porous microspheres treated with sodium hydroxide solution, and then loading mixed resin powder, Table 2 shows that the antibacterial rate of the regenerated cellulose film is increased, and the barrier property of water vapor is improved, and the water vapor transmission rate at the heat sealing place decreases, indicating that after the regenerated cellulose film is heat sealed, the heat sealing position can have good barrier property.

The heat-sealing auxiliary of Examples 6-8 in Embodiments 9-11 respectively compared with Example 5, in the regenerated cellulose membrane prepared in Embodiment 9 without adding dodecyl mercaptan, dopamine solution and silver nitrate respectively, the porosity in the hollow porous microspheres of PDLLA decreases, so that the loading of mixed resin powder decreases, and the heat-sealing strength is reduced. But after heat sealing, the water resistance of the heat-sealing position decreases, indicating that dodecyl thiol can improve the hydrophobicity of the pores in the hollow porous microspheres of PDLLA, so that the PDLLA hollow porous microspheres in a porous state still have good barrier property after the mixed resin powder is heat sealed. However, the porosity of PDLLA hollow porous microspheres in the heat-sealing auxiliaries at the untreated heat-sealing position was reduced, and the water blocking performance was improved. In Embodiment 10, the barrier property of the regenerated cellulose film is weakened, and the heat sealing strength increases, indicating that the use of dopamine solution can increase the cohesiveness of nano-silver particles, and improve the antibacterial and barrier properties of the regenerated cellulose film, and can make the loading of mixed resin powder decrease, resulting in a certain weakening of heat sealing strength. When silver nitrate was not added in Embodiment 11, the porosity of PDLLA hollow porous microspheres was not reduced, and the heat-sealing strength was similar to that of Embodiment 8. However, its antibacterial property decreases, and the water resistance of the heat seal and the water resistance of the film itself decreases.

The heat sealing auxiliary of Example 9 in Embodiment 12, compared with the that of Example 1, the preparation of the heat sealing auxiliary using polyethyleneimine, carboxyl carbon nanotubes, and the solution of octadecyl trichlorosilane is used in the preparation of the heat sealing auxiliary agent in Example 9, and the regenerated cellulose membrane prepared in the embodiment 12 is enhanced in the barrier property of water, and the mechanical strength is improved.

The heat sealing auxiliary of example 10 in embodiment 13, compared with embodiment 12, in which the octadecyl trichlorosilane solution is not added, the barrier property of the regenerated cellulose film in embodiment 13 decreases, and the barrier property of the heat sealing position is also reduced, and the mechanical strength is slightly reduced.

The heat-sealing auxiliary of Example 11 in Embodiment 14, in which no carboxylate carbon nanotubes are added, and compared with Example 12, the water-blocking property of the regenerated cellulose film prepared in Embodiment 14 decreases, and the barrier property is weakened.

The heat sealing auxiliary of Example 12 in Embodiment 15, compared with Example 1, not only the PDLLA hollow porous microspheres are pretreated, but also the heat sealing auxiliary made by utilizing components such as polyethyleneimine is also pretreated, and compared with Embodiment 8 and the Embodiment 12, the regenerated cellulose film made in the Embodiment 15 has good barrier properties and heat sealing strength, and the water resistance at the heat sealing place is also better.

Embodiment 16 is also post-treated with PDMS solution, peppermint essential oil microcapsules, and dodecyltrimethoxysilane compared with Embodiment 15, and the antibacterial ability of the obtained regenerated cellulose membrane is improved, and the surface barrier property is improved.

Embodiment 17 compared with Embodiment 16, peppermint essential oil microcapsules are not added, and the antibacterial ability of the regenerated cellulose membrane prepared by Embodiment 17 decreases; Embodiment 18 does not add dodecyltrimethoxysilane, and compared with Embodiment 16, the barrier property of regenerated cellulose film to water vapor is weakened.

Compared with Embodiment 1, the water vapor barrier of the regenerated cellulose membrane prepared in proportion 1 is reduced without adding graphene oxide in proportion 1, polyvinyl alcohol is not added in proportion 2, and fraction 1 and fraction 2.

For a heat-sealing film with cellulose as raw material prepared by the prior art in proportion 3, it can be seen that its heat-sealing strength is not as good as that of Embodiment 1, and the water vapor barrier is not good.

### Performance Testing of Composite Packaging

Composite packaging bags from outside to inside successively include high-barrier double-sided heat-sealed regenerated cellulose film, degradable glue and PBS film, composite packaging film from outside to inside includes high-barrier double-sided heat-sealed regenerated cellulose film, degradable glue and PLA aluminized film, and high-barrier double-sided heat-sealed regenerated cellulose film is made of Embodiment 1, Embodiment 8, Embodiment 12, Embodiment 15, and Embodiment 16 respectively, in accordance with GB/T1037-2021 and GB/T1038-2000 detects the water vapor and oxygen transmission rates of composite packaging bags and composite packaging films, respectively, and records the test results in Table 3.

TABLE 3
Performance test results of composite packaging film

| | project | | | |
|---|---|---|---|---|
| | Composite bags | | Laminated packaging film | |
| | g/m² · | cm³/ | g/m² · | cm³/ |
| | 24 h | (m² · d · Pa) | 24 h | (m² · d · Pa) |
| Embodiment 1 | 2.65 | 1.24 | 1.93 | 0.71 |
| Embodiment 8 | 2.51 | 1.11 | 1.81 | 0.62 |
| Embodiment 12 | 2.43 | 1.02 | 1.62 | 0.54 |
| Embodiment 15 | 2.31 | 0.87 | 1.48 | 0.50 |
| Embodiment 16 | 2.15 | 0.76 | 1.43 | 0.43 |

It can be seen from the data in Table 3 that the high-barrier double-sided heat-sealed regenerated cellulose film prepared by the present application has more excellent barrier performance after being compounded with packaging materials such as PBS film or PLA aluminized film by degradable glue, which makes the application range of high-barrier double-sided heat-sealed regenerated cellulose film more extensive.

The present specific embodiment is only an interpretation of the present application, and it is not a restriction on the present application, and those skilled in the art may, after reading the present specification, make modifications to the present embodiment without inventive contribution as needed, but as long as they are protected by the patent law within the scope of the claims of the present application.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A high-barrier double-sided heat-sealed regenerated cellulose film comprising:
30-60 weight parts of cellulose raw materials;
4.5-9 weight parts of plasticizer;
3-15 weight parts of polyvinyl alcohol;
10-20 weight parts of graphene oxide; and
15-30 weight parts of a heat-sealing auxiliary agent.

2. The high-barrier double-sided heat-sealed regenerated cellulose film of claim 1, wherein the heat-sealing auxiliary agent is poly-d,l-lactic acid (PDLLA) hollow porous microspheres loaded with resins.

3. The high-barrier double-sided heat-sealed regenerated cellulose film of claim 2, wherein the resins comprise (Polycaprolactone) PCL resin.

4. The high-barrier double-sided heat-sealed regenerated cellulose film of claim 3, wherein the resins further comprise EVA resin, wherein the heat-sealing auxiliary agent is made by a process comprising:
mixing grounded PCL resin and low melting point EVA resin to obtain a resin powder, wherein a mass ratio of the PCL resin to the low melting point EVA resin is 1:0.1-0.3; and
adding the resin powder to a dispersion of pretreated PDLLA hollow porous microspheres in ethanol.

5. The high-barrier double-sided heat-sealed regenerated cellulose film of claim 4, wherein the process of preparing the heat-sealing auxiliary agent further comprises:
adding PDLLA hollow porous microspheres in dopamine solution and stirring to obtain first treated PDLLA hollow porous microspheres;
adding silver nitrate solution to the first treated PDLLA hollow porous microspheres to obtain second treated PDLLA hollow porous microspheres; and
upon drying, impregnating the second treated PDLLA hollow porous microspheres in dodecyl thiol solution to obtain third treated PDLLA hollow porous microspheres, wherein the resin powder is added to a dispersion of the third treated PDLLA hollow porous microspheres.

6. The high-barrier double-sided heat-sealing regenerated cellulose film of claim 5, wherein the process of preparing the heat-sealing auxiliary agent further comprises:
adding third treated PDLLA hollow porous microspheres in polyethyleneimine solution of a concentration of 45-50 wt. %;
adding carboxylate carbon nanotubes to obtain a fourth treated PDLLA hollow porous microspheres; and
adding octadecyl trichlorosilane solution.

7. The high-barrier double-sided heat-sealing regenerated cellulose film of claim 6, wherein the PDLLA hollow porous microspheres are treated with sodium hydroxide solution before treating with the dopamine solution.

8. The high-barrier double-sided heat-sealing regenerated cellulose film of claim 4, wherein the pretreated PDLLA hollow porous microspheres are obtained by treating the PDLLA hollow porous microspheres with polydopamine, nano-silver particles, and dodecyl thiol.

9. The high-barrier double-sided heat-sealed regenerated cellulose film of claim 1, wherein the PDLLA hollow porous microspheres are prepared by a method comprising:
dissolving PDLLA in ethyl acetate;
adding ammonium bicarbonate solution; and
adding polyvinyl alcohol solution resulting in the formation of microspheres.

10. The high-barrier double-sided heat-sealed regenerated cellulose film of claim 1, wherein the plasticizer comprises glycerol and sorbitol in a mass ratio of 1:0.5-1.

11. A method of preparing high-barrier double-sided heat-sealing regenerated cellulose film, the method comprising:
adding cellulose raw material to a solvent;
adding a plasticizer to obtain a cellulose solution;
adding polyvinyl alcohol to deionized water to obtain a polyvinyl alcohol solution;
adding graphene oxide and heat-sealing auxiliary agent to the polyvinyl alcohol solution to obtain a treatment solution;
mixing cellulose solution and the treatment solution to obtain a mixture; and
preparing the high-barrier double-sided heat-sealing regenerated cellulose film from the mixture.

12. The method of claim 11, wherein the method further comprises:
scaping a layer of the mixture on a PTFE board;
upon solidification in a solidification bath, washing the layer in deionized water to neutral; and
hot-pressing and drying at 60-65° C. to prepare the high-barrier double-sided heat-sealing regenerated cellulose film.

12. The method of claim 11, wherein the heat-sealing auxiliary agent is poly-d,l-lactic acid (PDLLA) hollow porous microspheres loaded with resins.

13. The method of claim 12, wherein the resins comprise (Polycaprolactone) PCL resin.

14. The method of claim 13, wherein the resins further comprise EVA resin, wherein the method further comprises preparing the heat-sealing auxiliary agent by a process comprising:
mixing grounded PCL resin and low melting point EVA resin to obtain a resin powder, wherein a mass ratio of the PCL resin to the low melting point EVA resin is 1:0.1-0.3; and
adding the resin powder to a dispersion of pretreated PDLLA hollow porous microspheres in ethanol.

15. The method of claim 14, wherein the process of preparing the heat-sealing auxiliary agent further comprises:
treating PDLLA hollow porous microspheres with sodium hydroxide solution.

16. The method of claim 15, wherein the process of preparing the heat-sealing auxiliary agent further comprises:
upon sodium hydroxide treatment, adding the PDLLA hollow porous microspheres in dopamine solution and stirring to obtain first treated PDLLA hollow porous microspheres;
adding silver nitrate solution to the first treated PDLLA hollow porous microspheres to obtain second treated PDLLA hollow porous microspheres; and
upon drying, impregnating the second treated PDLLA hollow porous microspheres in dodecyl thiol solution to obtain third treated PDLLA hollow porous microspheres, wherein the resin powder is added to a dispersion of the third treated PDLLA hollow porous microspheres.

17. The method according to claim 16, wherein the process of preparing the heat-sealing auxiliary agent further comprises:
Adding the third treated PDLLA hollow porous microspheres in polyethyleneimine solution of a concentration of 45-50 wt. %;
adding carboxylate carbon nanotubes to obtain a fourth treated PDLLA hollow porous microspheres; and
adding octadecyl trichlorosilane solution.

18. The method of claim 14, wherein the pretreated PDLLA hollow porous microspheres are obtained by treating the PDLLA hollow porous microspheres with polydopamine, nano-silver particles, and dodecyl thiol.

19. The method of claim 15, wherein the PDLLA hollow porous microspheres are prepared by a method comprising:
dissolving PDLLA in ethyl acetate;
adding ammonium bicarbonate solution, and
adding polyvinyl alcohol solution resulting in the formation of microspheres.
The method of claim 11, wherein the plasticizer comprises glycerol and sorbitol in a mass ratio of 1:0.5-1.
